(19) United States
(12) Patent Application Publication
(10) Pub. No.: US 2020/0301349 A1
(43) Pub. Date: Sep. 24, 2020

(54) CONNECTING DEVICE, CASING, AND IMAGE FORMING APPARATUS

(71) Applicants: Taisuke ISHIKAWA, Kanagawa (JP); Junichi MURANO, Tokyo (JP); Hiroki ISHIMITSU, Kanagawa (JP)

(72) Inventors: Taisuke ISHIKAWA, Kanagawa (JP); Junichi MURANO, Tokyo (JP); Hiroki ISHIMITSU, Kanagawa (JP)

(73) Assignee: Ricoh Company, Ltd., Tokyo (JP)

(21) Appl. No.: 16/813,188

(22) Filed: Mar. 9, 2020

(30) Foreign Application Priority Data
Mar. 19, 2019 (JP) 2019-050614

(51) Int. Cl. G03G 21/16

(52) U.S. Cl. CPC G03G 21/1619

(57) ABSTRACT

A connecting device includes a connected member and a connecting member connected to the connected member. The connecting member includes a contact portion contacting a surface of the connected member and a flat spring sandwiching the connected member together with the contact portion. The connected member includes a passage hole through which the contact portion passes, a communication hole communicating with the passage hole and narrower than the passage hole, and a holding portion disposed around the communicating hole. The holding portion holds the contact portion.

### CROSS-REFERENCE TO RELATED APPLICATION

This patent application is based on and claims priority pursuant to 35 U.S.C. § 119(a) to Japanese Patent Application No. 2019-050614, filed on Mar. 19, 2019, in the Japan Patent Office, the entire disclosure of which is hereby incorporated by reference herein.

### BACKGROUND

### Technical Field

This disclosure relates to a connecting device, a casing, and an image forming apparatus.

### Description of the Related Art

As an example of a connecting device, there is known a circuit board holder disposed between a first circuit board and a second circuit board. The circuit board holder includes a first latch passing through an opening of the first circuit board to engage the first circuit board and a second latch passing through an opening of the second circuit board to engage the second circuit board.

There is also known a laser printer that includes a metal plate spring to connect a power supply box of a lower frame and an upper frame to the ground.

### SUMMARY

In an aspect of the present disclosure, there is provided a connecting device that includes a connecting member and a connected member. The connecting member is connected to the connected member. The connecting member includes a contact portion contacting a surface of the connected member and a flat spring configured to sandwich the connected member together with the contact portion. The connected member includes a passage hole through which the contact portion passes, a communication hole communicating with the passage hole and narrower than the passage hole, and a holding portion disposed around the communicating hole and configured to hold the contact portion.

In another aspect of the present disclosure, there is provided a casing that includes the connecting device. The connected member is a frame of the connecting device, and the connecting member is a grounding conductor electrically connected with the connected member.

In still another aspect of the present disclosure, there is provided an image forming apparatus that includes the casing and an image forming device. The image forming device is disposed in the casing and configured to form an image.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a perspective view of a casing according to an embodiment of present disclosure;

FIG. 2 is a schematic view of a connection state between a frame and a grounding conductor according to an embodiment of the present disclosure;

FIG. 3 is a schematic view of holes of the frame according to an embodiment of the present disclosure;

FIG. 4 is a schematic view of the frame and an exterior cover according to an embodiment of the present disclosure;

FIG. 5 is a perspective view of the grounding conductor according to an embodiment of the present disclosure;

FIG. 6 is a front view of the grounding conductor according to an embodiment of the present disclosure;

FIG. 7 is a perspective view of a connection state between another frame and another grounding conductor according to a variation of an embodiment of the present disclosure;

FIG. 8 is a perspective view of a connection state between another frame and another grounding conductor according to a second variation of an embodiment of the present disclosure;

FIG. 9 is a schematic view of a connection state between a common frame and an extension frame according to an embodiment of the present disclosure;

FIG. 10 is a schematic view of a connection state between the common frame, the extension frame, a second extension frame and a third extension frame according to an embodiment of the present disclosure; and

FIG. 11 is a schematic view of image forming apparatuses according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present disclosure are described below with reference to attached drawings. In the drawings for explaining exemplary embodiments of this disclosure, identical reference numerals are assigned as long as discrimination is possible to components such as members and component parts having an identical function or shape, thus omitting a description thereof once the description is provided.

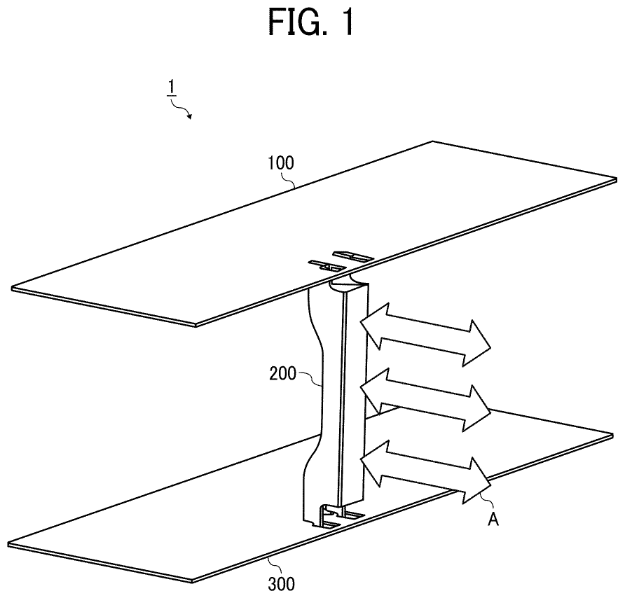

FIG. 1 is a perspective view of a casing according to an embodiment of present disclosure.

A casing 1 (an example of a connecting member) includes a planar frame 100 (an example of a connected member), another planar frame 300 (an example of another connected member), and a grounding conductor 200 (an example of a connecting member). The frame 100 and the frame 300 are disposed facing each other. The grounding conductor 200 is connected to both the frame 100 and the frame 300.

The grounding conductor 200 is electrically connected to both the frame 100 and the other frame 300 and has electrical continuity with the frame 100 and the other frame 300.

The grounding conductor 200 is slidable in directions indicated by arrow A and can be connected to or detached from the frame 100 and the other frame 300.

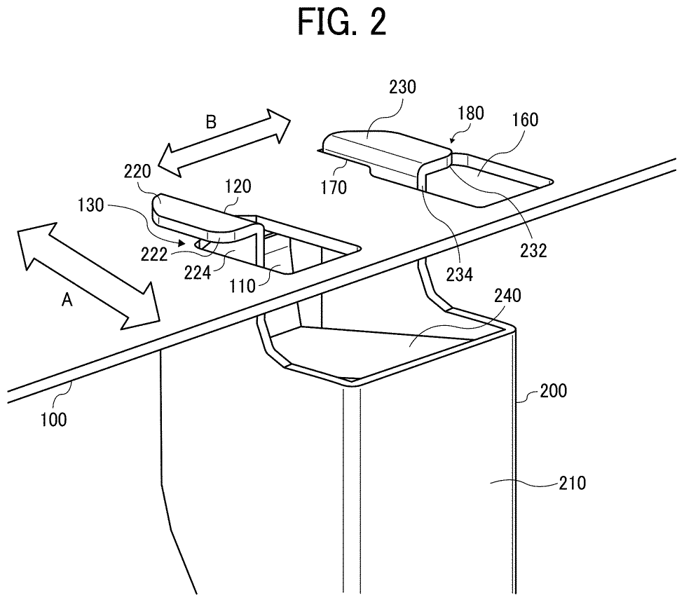

FIG. 2 is a schematic view of a connection state of the frame 100 and the grounding conductor 200 according to an embodiment of the present disclosure.

FIG. 2 illustrates a connection state between the frame 100 and the grounding conductor 200. The frame 300 and the grounding conductor 200 are also connected in the same configuration as in FIG. 2.

The grounding conductor 200 includes a grounding conductor body 210, a first connector 224, and a second connector 234. Both the first connector 224 and the second connector 234 are integrated with the grounding conductor body 210. The grounding conductor 200 also includes a first bent portion 220, a second bent portion 230, and a flat spring 240. The first bent portion 220 is integrated with the first connector 224 and bent in the normal direction of a surface of the first connector 224. The second bent portion 230 is integrated with the second connector 234 and bent in the normal direction of a surface of the second connector 234.

The first bent portion 220 and the second bent portion 230 are spaced apart from each other in directions indicated by arrow B. A first contact portion (contact surface) 222 and a second contact portion (contact surface) 232 are formed on the first bent portion 220 and the second bent portion 230, respectively, and contact a surface of the frame 100. Note that the directions of arrow B are parallel to the surface of the frame 100 and perpendicular to the directions of arrow A.

The frame 100 includes a first passage hole 110, a second passage hole 160, a first communication hole 120, and a second communication hole 170. The first passage hole 110 and the second passage hole 160 have a size such that the first bent portion 220 and the second bent portion 230 can pass through the first passage hole 110 and the second passage hole 160, respectively. The first communication hole 120 and the second communication hole 170 are communicated with the first passage hole 110 and the second passage hole 160, respectively. The first communication hole 120 and the second communication hole 170 have a smaller width than the first passage hole 110 and the second passage hole 160. The first communication hole 120 and the second communication hole 170 have a size which prevents the first bent portion 220 and the second bent portion 230 from passing through the first communication hole 120 and the second communication hole 170, respectively.

A first holding portion (holding surface) 130 and a second holding portion (holding surface) 180 are formed around the first communication hole 120 and the second communication hole 170. The first holding portion 130 and the second holding portion 180 contact and hold a first contact portion 222 and a second contact portion 232, respectively.

The first passage hole 110, the first communication hole 120, and the first holding portion 130 are spaced apart from the second passage hole 160, the second communication hole 170, and the second holding portion 180 in the directions of arrow B. Such an arrangement can position the grounding conductor 200 with respect to the frame 100 in the directions of the arrow B.

In a state illustrated in FIG. 2, the first contact portion 222 and the second contact portion 232 contact and are held by the first holding portion 130 and the second holding portion 180, respectively.

Further, the flat spring 240 is disposed between the first contact portion 222 and the second contact portion 232 in the directions of arrow B. The flat spring 240, together with the first contact portion 222 and the second contact portion 232, sandwiches the frame 100 and have electrical continuity with the frame 100.

In the state illustrated in FIG. 2, when removing the grounding conductor 200 from the frame 100, first, the grounding conductor 200 is moved in the right downward direction of arrow A (from the first and second communication holes 120 and 170 toward the first and second passage holes 110 and 160). This movement allows the first bent portion 220 and the second bent portion 230 to move from above the first holding portion 130 and the second holding portion 180 to above the first passage hole 110 and the second passage hole 160, respectively.

Then, moving the grounding conductor 200 downward in FIG. 2, that is, the normal direction to a surface of the frame 100 allows the first bent portion 220 and the second bent portion 230 to pass through the first passage hole 110 and the second passage hole 160, respectively. Thus, the grounding conductor 200 can be detached from the frame 100.

By contrast, when connecting the grounding conductor 200 with the frame 100, first, the grounding conductor 200 is moved from below the frame 100 toward above the frame 100. This allows the first bent portion 220 and the second bent portion 230 to pass through the first passage hole 110 and the second passage hole 160, respectively.

When the grounding conductor 200 is moved in the left upward direction of arrow A (from the first and second passage holes 110 and 160 toward the first and second communication holes 120 and 170), the grounding conductor 200 is positioned in the state illustrated in FIG. 2.

For example, in a case of a comparative configuration including latches that penetrate openings of circuit boards and engage with the circuit boards, the user needs to access a back side of each circuit board and pinch the latch to detach the latch from the opening while pinching the latch. By contrast, in the present embodiment, the user can easily detach the grounding conductor 200 from the frame 100 simply by moving the grounding conductor 200 in the right downward direction of arrow A and then vertically downward in FIG. 2.

In the above-described comparative configuration, it is difficult to penetrate the latch through the opening and attach the latch to each circuit board after the distance between the two circuit boards is fixed. However, in the present embodiment, even after the distance between the frame 100 and the frame 300 is fixed, the user can pass the first bent portion 220 and the second bent portion 230 through the first passage hole 110 and the second passage hole 160 while tilting the grounding conductor 200. As a result, the user can easily attach the grounding conductor 200 to the frame 100.

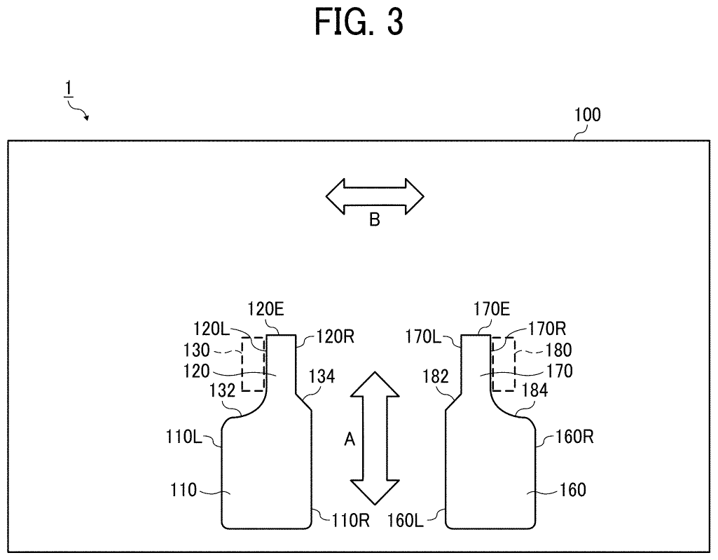

FIG. 3 is a schematic view of holes of the frame 100 according to an embodiment of the present disclosure.

The first passage hole 110 includes a first left end 110L and a first right end 110R. The first communication hole 120 includes a first left end 120L, a first right end 120R, and a first edge 120E. The first holding portion 130 is arranged adjacent to an outside (left side) of the first communication hole 120 in the leftward direction of arrow B. The first left end 110L and the first left end 120L are connected via a left connecting portion 132, and the first right end 110R and the first right end 120R are connected via a right connecting portion 134.

The distance between the first left end 110L and the first right end 110R is larger than a width of the first bent portion 220 in the directions of arrow B. The length of a shorter one of the first left end 110L and the first right end 110R is larger than the length of the first bent portion 220 in the directions of arrow A. As a result, the first bent portion 220 can pass through the first passage hole 110.

The distance between the first left end 120L and the first right end 120R is smaller than each of the distance between the first left end 110L and the first right end 110R and a width of the first bent portion 220 in the directions of arrow B. The distance between the first left end 120L and the first right end 120R is larger than a width of the first connector 224 in the directions of arrow B. As a result, the first bent portion 220 does not pass through the first communication hole 120.

Abutting an end of the first connector 224 to the first edge 120E in the upward direction of arrow A in FIG. 3 causes the first bent portion 220 to be positioned in a direction moving from the first passage hole 110 to the first communication hole 120.

The second passage hole 160 includes a second left end 160L and a second right end 160R. The second communication hole 170 includes a second left end 170L, a second right end 170R, and a second edge 170E. The second holding portion 180 is disposed adjacent to an outside (right side) of the second communication hole 170 in the rightward direction of arrow B in FIG. 3. The second left end 160L and the second left end 170L are connected via a left connecting portion 182. The second right end 160R and the second right end 170R are connected via a right connecting portion 184.

The distance between the second left end 160L and the second right end 160R is larger than a width of the second bent portion 230 in the directions of arrow B. The length of a shorter one of the second left end 160L and the second right end 160R is larger than the length of the second bent portion 230 in the directions of arrow A. As a result, the second bent portion 230 can pass through the second passage hole 160.

The distance between the second left end 170L and the second right end 170R is smaller than each of the distance between the second left end 160L and the second right end 160R and a width of the second bent portion 230 in the directions of arrow B. The distance between the second left end 170L and the second right end 170R is larger than a width of the second connector 234 in the directions of arrow B. As a result, the second bent portion 230 does not pass through the second communication hole 170.

Abutting an end of the second connector 234 to the second edge 170E in the upward direction of arrow A in FIG. 3 allows the second bent portion 230 to be positioned in a direction moving from the second passage hole 160 to the second communication hole 170.

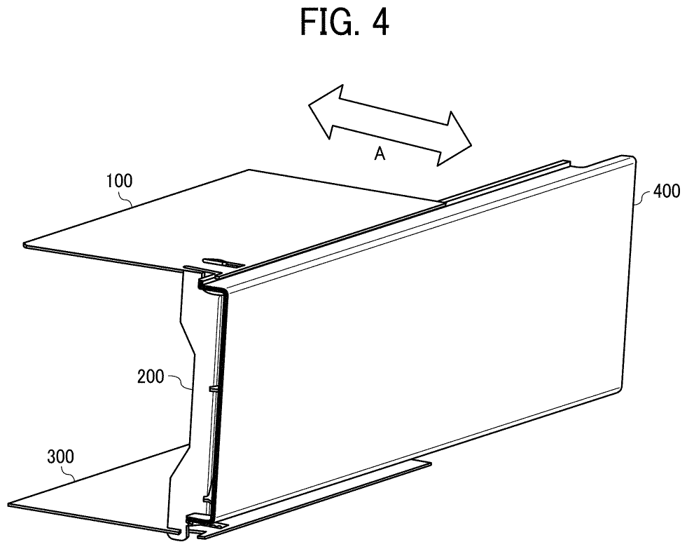

FIG. 4 is a schematic view of a state in which an exterior cover 400 is attached to the frames 100 and 300 according to an embodiment of the present disclosure.

In FIG. 4, the exterior cover 400 (an example of an attachment) is attached to the frame 100 and the other frame 300 in a leftward direction of arrow A from the right side.

As a result, the grounding conductor 200 is pressed by the exterior cover 400. Accordingly, ends of the first connector 224 and the second connector 234 illustrated in FIG. 2 abut the first edge 120E and the second edge 170E, respectively, illustrated in FIG. 3, and the grounding conductor 200 is positioned relative to the frame 100 and the frame 300 in the leftward direction of arrow A. Since the grounding conductor 200 serves as a backing of the exterior cover 400, quality and robustness are enhanced.

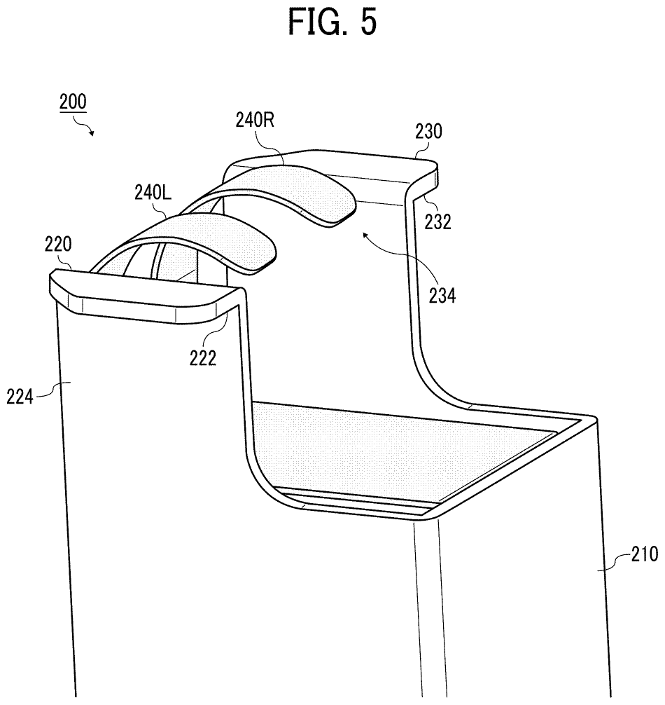

FIG. 5 is a perspective view of the grounding conductor 200 according to an embodiment of the present disclosure.

The flat spring 240 includes a left flat spring 240L and a right flat spring 240R disposed between the first contact portion 222 and the second contact portion 232.

The left flat spring 240L and the right flat spring 240R each have elasticity and are connected to the rigid grounding conductor body 210 by a generally known method such as welding, caulking, or screw fastening. Portions of the left flat spring 240L and the right flat spring 240R that contact the frame 100 deforms reversibly due to elasticity.

When burr sides of the left flat spring 240L and the right flat spring 240R are faced against the frame 100, a surface of the frame 100 contacts the left flat spring 240L and the right flat spring 240R and is damaged. As a result, electrical continuity between the frame 100 and each of the left flat spring 240L and the right flat spring 240R is enhanced, and electrical grounding is enhanced.

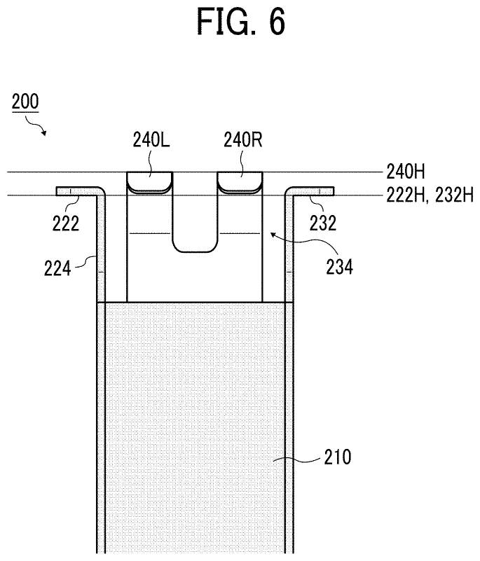

FIG. 6 is a front view of the grounding conductor 200 according to an embodiment of the present disclosure.

FIG. 6 is a view of a state in which the grounding conductor 200 is not connected to the frame 100. An upper face 240H of the left flat spring 240L and the right flat spring 240R is located above a height 222H of the first contact portion 222 and a height 232H of the second contact portion 232. In other words, the left flat spring 240L and the right flat spring 240R are located at a side (upper side) opposite to a normal direction (lower side) of each of the first contact portion 222 and the second contact portion 232 relative to the first contact portion 222 and the second contact portion 232.

Owing to this structure, in a state in which the grounding conductor 200 is connected to the frame 100, the left flat spring 240L and the right flat spring 240R elastically deform by only a difference of height between the upper face 240H and each of the height 222H and the height 232H. As a result, the left flat spring 240L and the right flat spring 240R reliably contact the frame 100 by a large elastic force. Thus, electrical continuity and electrical grounding are enhanced.

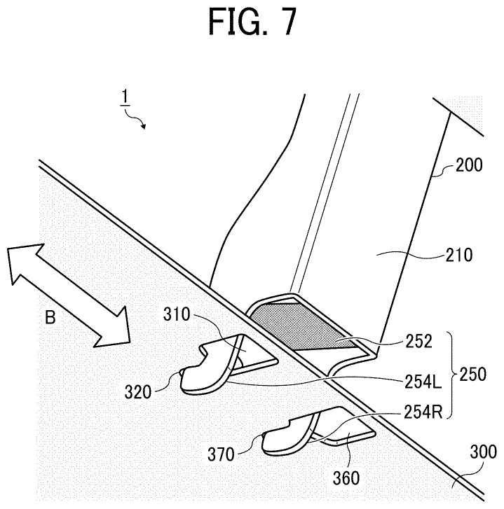

FIG. 7 is a view of a connection state between the other frame 300 and the grounding conductor 200 according to a variation of an embodiment of the present disclosure.

The connection between the frame 300 and the grounding conductor 200 is not limited to the same configuration as the connection between the frame 100 and the grounding conductor 200 illustrated in FIG. 2. For example, the connection may be a configuration described as follows.

The grounding conductor 200 includes a connection portion 250 that is connected to the frame 300. The connection portion 250 includes a left protrusion 254L and a right protrusion 254R connected to the grounding conductor body 210 and another flat spring 252. The left protrusion 254L and the right protrusion 254R are spaced apart in the directions of arrow B.

The frame 300 includes a first passage hole 310, a second passage hole 360, a first communication hole 320, and a second communication hole 370. The first passage hole 310 and the second passage hole 360 have a size which allows the left protrusion 254L and the right protrusion 254R to pass through the first passage hole 310 and the second passage hole 360, respectively. The first communication hole 320 and the second communication hole 370 are connected with the first passage hole 310 and the second passage hole 360, respectively, and have a narrower width than the first passage hole 310 and the second passage hole 360, respectively. The first communication hole 320 and the second communication hole 370 have a size which prevents the left protrusion 254L and the right protrusion 254R from passing through the first communication hole 320 and the second communication hole 370, respectively.

The first passage hole 310 and the first communication hole 320 are spaced apart from the second passage hole 360 and the second communication hole 370 in the directions of arrow B.

When the frame 300 and the grounding conductor 200 are connected, the frame 100 and the frame 300 are already positioned in the normal direction of the surface of the frame 300, and the frame 300 and the grounding conductor 200 are positioned. Therefore, it is not necessary to newly position the frame 300 and the grounding conductor 200. In other words, a contact portion or a holding portion as illustrated in FIG. 2 does not need to be provided.

In such a case, the left protrusion 254L and the right protrusion 254R pass through the first passage hole 310 and the second passage hole 360 respectively. As a result, the other flat spring 252 can contact the frame 300. Accordingly, the flat spring 252 and the flat spring 240 illustrated in FIG. 2 have electrical continuity, which enables the frame 100 and the frame 300 to have electrical continuity.

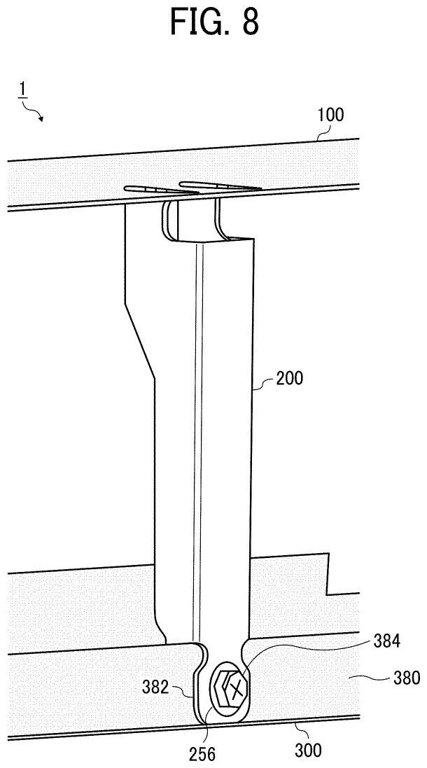

FIG. 8 is a view of a connection state between the other frame 300 and the grounding conductor 200 according to a second variation of an embodiment of the present disclosure.

The connection between the frame 300 and the grounding conductor 200 is not limited to the same configuration as the connection between the frame 100 and the grounding conductor 200 illustrated in FIG. 2. For example, the connection may be a configuration described as follows.

The frame 300 includes a flange 380, and the flange 380 includes a screw hole 382.

The grounding conductor 200 includes a screw hole 256. A screw 384 is fastened to the flange 380 via the screw hole 256 and the screw hole 382 to position the grounding conductor 200 to the frame 300.

In this case, the direction in which the screw 384 is fastened is the same as one of the directions in which the grounding conductor 200 illustrated in FIG. 1 slides. Therefore, the grounding conductor 200 can be easily connected to or detached from the frame 100 and the other frame 300.

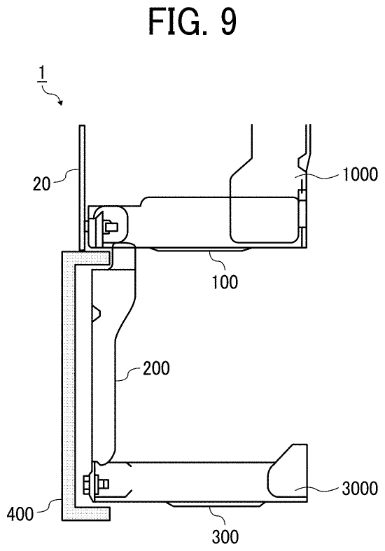

FIG. 9 is a schematic view of a connection state between a common frame 1000 and an extension frame 3000 according to an embodiment of the present disclosure.

As illustrated in FIG. 9, the frame 100 serves as a bottom surface of the common frame 1000, and the other frame 300 serves as a bottom surface of the extension frame 3000 that is added to the common frame 1000. A common exterior cover 20 is attached to the common frame 1000.

The common frame 1000 is used for an image forming apparatus with a small-capacity sheet feeding tray(s) and the like. The extension frame 3000 is used as a sheet feeding tray dedicated for an image forming apparatus with a large sheet capacity. In the present embodiment, when the extension frame 3000 is added to the common frame 1000, the grounding conductor 200 can be easily connected to the common frame 1000 and the extension frame 3000 only by sliding the grounding conductor 200 in the left upward direction of arrow A illustrated in FIG. 2 and the like. As a result, a sheet feeding tray or the like having ground connection can be easily added.

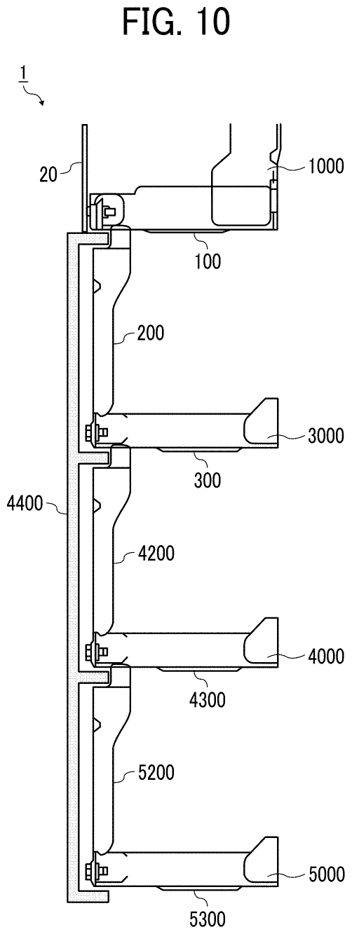

FIG. 10 is a schematic view of a connection state between the common frame 1000, the extension frame 3000, a second extension frame 4000 and a third extension frame 5000 according to an embodiment of the present disclosure.

In FIG. 10, in addition to the configuration illustrated in FIG. 9, the second extension frame 4000 and the third extension frame 5000 added to the extension frame 3000 are provided. A second exterior cover 4400 (an example of an attachment of a second attachment set) is attached to the common frame 1000, the extension frames 3000, 4000, and 5000.

The second extension frame 4000 includes a second grounding conductor 4200 (an example of a connecting member of the second attachment set) and a second frame 4300 (an example of a connected member of the second attachment set). The second grounding conductor 4200 is connected to the frame 300. The frame 4300 is connected to the second grounding conductor 4200 and serves as a bottom surface of the extension frame 4000.

The third extension frame 5000 includes a third grounding conductor 5200 (an example of a connecting member of a third attachment set) and a third frame 5300 (an example of a connected member of the third attachment set). The grounding conductor 5200 is connected to the frame 4300. The third frame 5300 is connected to the grounding conductor 5200 and serves as a bottom surface of the extension frame 5000.

The common frame 1000 is used for an image forming apparatus with a small-capacity sheet feeding tray(s) and the like. The extension frame 5000 is used as a sheet feeding tray dedicated for an image forming apparatus with a large sheet capacity. In the present embodiment, when the extension frames 3000, 4000, and 5000 are added to the common frame 1000, the grounding conductor 200 can be easily connected to the common frame 1000 and the extension frames 3000, 4000, and 5000 only by sliding the grounding conductor 200 in the left upward direction of arrow A illustrated in FIG. 2 and the like. As a result, a sheet feed tray or the like having ground connection can be easily added.

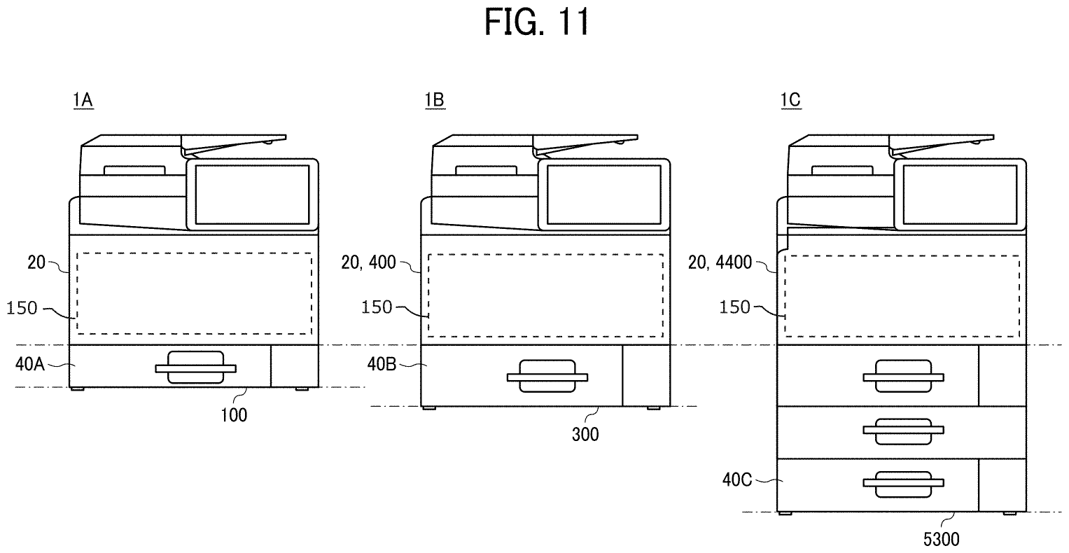

FIG. 11 is a schematic view of image forming apparatuses according to an embodiment of the present disclosure.

Image forming apparatuses 1A, 1B, and 1C illustrated in FIG. 11 each include a casing 1 that includes an image forming device 150 to form an image.

The image forming apparatus 1A includes a small-capacity sheet feeding tray 40A, a common exterior cover 20, and a frame 100 disposed at the bottom of the apparatus.

The image forming apparatus 1B includes the casing 1 illustrated in FIG. 9, a large-capacity sheet feeding tray 40B, the common exterior cover 20, an exterior cover 400, and the frame 300 disposed at the bottom of the apparatus.

The image forming apparatus 1C includes the casing 1 illustrated in FIG. 10, a multiple sheet feeding tray 40C, the common exterior cover 20, a second exterior cover 4400, and the third frame 5300 disposed at the bottom of the apparatus.

For image forming apparatus, a lineup of models with different sheet tray capacities and different numbers of sheet feeding trays may be produced depending on the market needs. In such a case, if a basic system is built as a small-sized model like the image forming apparatus 1A, frames can be added to the basic system to produce a model with an increased sheet feed capacity like the image forming apparatus 1B and the image forming apparatus 1C. Thus, many parts that are not related to the change of sheet feeding trays can be standardized, and cost reduction can be achieved.

In the above descriptions, the term “printing” in the present disclosure may be used synonymously with, e.g. the terms of “image formation”, “recording”, “printing”, and “image printing”. Further, the coater according to an embodiment of the present disclosure can also be applied to an apparatus that performs printing on an electrophotographic process on a sheet material coated with a coating liquid.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

What is claimed is:

1. A connecting device comprising:
a connected member; and
a connecting member connected to the connected member,
the connecting member including:
a contact portion contacting a surface of the connected member; and
a flat spring sandwiching the connected member together with the contact portion, and
the connected member including:
a passage hole through which the contact portion passes;
a communication hole communicating with the passage hole and being narrower than the passage hole; and
a holding portion disposed around the communicating hole, the holding portion holding the contact portion.

2. The connecting device according to claim 1,
wherein the communication hole is narrower than the passage hole in a direction orthogonal to a direction from the passage hole toward the communication hole.

3. The connecting device according to claim 1, further comprising an attachment attached from a direction parallel to the surface of the connected member,
wherein, with the attachment being attached to the connected member, the connecting member is sandwiched between an edge portion of the communication hole and the attachment and positioned relative to the edge portion of the communication hole.

4. The connecting device according to claim 3,
wherein the connected member is a frame of the connecting device and the attachment is an exterior cover of the connecting device.

5. The connecting device according to claim 1,
wherein the flat spring is located at a side opposite to a normal direction of the contact portion relative to the contact portion in a state in which the connecting member is not connected to the connected member.

6. The connecting device according to claim 1,
wherein the connecting member includes:
a first contact portion; and
a second contact portion, and
the first contact portion and the second contact portion are in contact with the surface of the connected member and spaced apart from each other in a direction parallel to the surface of the connected member,
wherein the connected member includes:
a first passage hole through which the first contact portion passes; and
a second passage hole through which the second contact portion passes, and
the first passage hole and the second passage hole are spaced apart from each other in the direction parallel to the surface of the connected member,
wherein the connected member includes:
a first communication hole communicated with the first passage hole and having a width narrower than a width of the first passage hole; and
a second communication hole communicated with the second passage hole and having a width narrower than a width of the second passage hole, and
the first communication hole and the second communication hole are spaced apart from each other in the direction parallel to the surface of the connected member, and
wherein the connected member includes:
a first holding portion disposed around the first communication hole, the first holding portion holding the first contact portion; and
a second holding portion disposed around the second communication hole, the second holding portion holding the second contact portion, and
the first holding portion and the second holding portion are spaced apart from each other in the direction parallel to the surface of the connected member.

7. The connecting device according to claim 6,
wherein the flat spring is disposed between the first contact portion and the second contact portion in the direction parallel to the surface of the connected member.

8. The connecting device according to claim 1, further comprising another connected member connected to the connecting member,
wherein the connecting member includes the contact portion and the flat spring at one end of the connecting member and a connection portion connected to said another connected member at another end of the connecting member opposite the one end.

9. The connecting device according to claim 8,
wherein the connection portion includes another flat spring contacting said another connected member.

10. The connecting device according to claim 9,
wherein both the flat spring and said another flat spring have conductivity and are electrically connected with each other.

11. The connecting device according to claim 8, further comprising a screw connecting the connection portion to said another connected member,
wherein a direction in which the screw is screwed is same as a direction from the passage hole toward the communication hole.

12. The connecting device according to claim 8,
wherein the connected member is a bottom surface of a frame of the connecting device,
wherein said another connected member is a bottom surface of another frame added to the connecting device, and
wherein a direction from the passage hole toward the communication hole is same as a direction from an outside of the connecting device toward a space between the bottom surface of the frame of the connecting device and the bottom surface of said another frame added to the connecting device.

13. A casing comprising the connecting device according to claim 1,
wherein the connected member is a frame of the connecting device, and the connecting member is a grounding conductor electrically connected with the connected member.

14. An image forming apparatus comprising:
the casing according to claim 13; and
an image forming device disposed in the casing and configured to form an image.
